(19) United States
(12) Patent Application Publication
(10) Pub. No.: US 2024/0383719 A1
(43) Pub. Date: Nov. 21, 2024

(54) Telescoping Branch Trimmer

(71) Applicant: Jeff Schwartz, Largo, FL (US)

(72) Inventor: Jeff Schwartz, Largo, FL (US)

(21) Appl. No.: 18/662,170

(22) Filed: May 13, 2024

Related U.S. Application Data
(63) Continuation-in-part of application No. 18/317,139, filed on May 15, 2023, now abandoned.

(51) Int. Cl. B65H 75/42; A01G 3/025; B25G 1/04; B65H 75/44; B65H 75/48

(52) U.S. Cl. CPC B65H 75/42; A01G 3/0255; B25G 1/04; B65H 75/4423; B65H 75/486

(57) ABSTRACT

A telescoping branch trimmer includes a telescoping pole. The telescoping pole has a telescoping lock for locking the length of the telescoping pole. A cutter head is mounted at one end of the telescoping pole and an actuation cord is interfaced to an actuator of the cutter head such that a pulling force applied to the actuation cord closes a cutting mechanism of the cutter head. An enclosure has a spring-loaded spool, a leader passing through the enclosure is interfaced to the spring-loaded spool for taking in the leader by spring force. The end of the leader that is distal from the enclosure is removably attached to the actuation cord (e.g., by a clip) to facilitate storage and replacement of the leader and enclosure. The leader is locked from entering/exiting the enclosure until an unlock button is pressed.

### BACKGROUND OF THE INVENTION

A branch trimmer (or pruner) is a device that cuts or lops off unwanted branches from landscaping such as trees. Many branch trimmers or pruners are handheld for trimming shrubs or low-hanging tree branches, but in order to trim tree branches that are too high to reach by a person standing on the ground, use of such handheld branch trimmers or pruners would require the user to scale a ladder, which is not always convenient and not always safe as the ground beneath the tree is often uneven or unstable.

To overcome this obstacle, telescoping tree branch trimmers are available. Telescopic tree branch trimmers are characterized by a telescoping pole that has a cutter head at one end. A cord is attached at one end to an actuator of the cutter head and there is a handle at the other end. After positioning a jaw of the cutter head around a branch, pulling on the cord (usually by the handle) effects cutting or loping off the branch. Often the telescoping pole has a non-extended length of around 7 feet and an extended length of between 12 feet and 18 feet. The cord is supplied at a length that is long enough to use when the telescoping pole is fully extended.

As is known by users of such telescoping tree branch trimmers, the cord and handle work great when the telescoping pole is fully extended and the handle of the cord is easily pulled as there is no slack in the cord, but for cutting lower branches when the telescoping pole is not fully extended, the cord often has too much slack and, therefore, the handle cannot be used and the user often resorts to wrapping the cord around their hand to provide enough leverage to close the jaws and cut a branch. After cutting many branches, this process often leads to an irritated hand and possibly to abrasions of the user's skin due to slippage of the cord. Further, having the long length of cord laying on the ground presents an opportunity for the user to trip over the cord, debris and dirt from the ground accumulating on the cord, and tangling or knotting of the cord.

Another problem with existing telescoping tree branch trimmers is storage of the cord when not in use. As the cord must be long enough to use when the telescoping pole is fully extended, the cord is typically 12 to over 18 feet long, making it difficult to store without tangling. Often, the cord is wrapped around the telescoping pole, but this requires many turns as the circumference of the telescoping pole is often only a few inches, maybe 3 inches. Dividing the length of the cord by 3 inches requires approximately 48 turns to wrap a 12-foot cord and another 48 turns to unwrap a 12-foot cord.

What is needed is a telescoping branch trimmer that that will adjust the cord length between the actuator of the cutter head and the handle to compensate for the length of the handle and to store the cord when the telescoping tree branch trimmer is not being used.

### SUMMARY OF THE INVENTION

In one embodiment, a telescoping branch trimmer is disclosed including a telescoping pole, the telescoping pole has a telescoping lock for locking the telescoping pole after the telescoping pole is adjusted to a desired length. At one end of the telescoping pole is a cutter head that has an actuation cord. One end of the actuation cord is connected to a cutting blade of the cutter head such that a pulling force applied to the actuation cord causes the cutting blade to close and an opposite end of the actuation cord ends in a loop. A first end of a leader is removably attached to the loop of the actuation cord. There is an enclosure having a handle portion and having there within a spool that is rotatably mounted to the enclosure. A second, distal end of the leader passes through the enclosure and is interfaced to the spool and the spool is configured to rotate within the enclosure to take in the leader, the spool is rotatably urged to take in the leader by a torsion spring. There is a locking mechanism interfaced to the enclosure such that the locking mechanism prevents the leader from entering or exiting the enclosure until an unlock button is operated at which time the torsion spring urges the spool to rotate and intake the leader onto the spool unless an outside force pulls on the leader, causing a force of the torsion spring to be overcome and, therefore, a portion of the leader exits the enclosure. The enclosure is not connected (disconnected) to the telescoping pole.

In another embodiment, a telescoping branch trimmer is disclosed including a telescoping pole that has a telescoping lock for locking the telescoping pole after the telescoping pole is adjusted to a desired length. A cutter head is mounted to one end of the telescoping pole. The cutter head has a cutting mechanism. The first end of an actuation cord is connected to the cutting mechanism such that applying a pulling force on a second end of the actuation cord closes a cutting mechanism. An enclosure has therein a spring-loaded spool and a leader passes into the enclosure. A first end of the leader is interfaced to the spring-loaded spool such that the spring-loaded spool is configured to wind or unwind a portion of the leader. A second end of the actuation cord is removably attached to a second end of the leader by a connector such that exertion of the pulling force on the leader causes the pulling force on the actuation cord to close the cutter head for cutting an object. The connector removably attaches to the second end of the actuation cord to the second end of the leader when operating the telescoping branch trimmer and the connector enables removal of the leader and the enclosure from the telescoping branch trimmer for storage and/or replacement.

In another embodiment, a method of replacing the leader using the telescoping branch trimmer is disclosed including adjusting the telescoping pole of the telescoping branch trimmer to a shortest length and operating the connector of the enclosure to release the leader from the actuation cord. Now the enclosure and leader can be stored or discarded. If the enclosure and/or leader are worn or broken, a second enclosure is provided a second leader and the connector of the second leader is operated to attach the second leader to the actuation cord.

### BRIEF DESCRIPTION OF DRAWINGS

The invention can be best understood by those having ordinary skill in the art by reference to the following detailed description when considered in conjunction with the accompanying drawings in which:

FIG. 1 illustrates a schematic view of a telescoping branch trimmer of the prior art.

FIG. 2 illustrates a schematic view of an improved telescoping branch trimmer with a cord self-retracting mechanism.

FIG. 2A illustrates a schematic view of an improved telescoping branch trimmer with a cord self-retracting mechanism that is detachable from the improved telescoping branch trimmer.

FIG. 2B illustrates a schematic view of an improved telescoping branch trimmer with a cord self-retracting mechanism that is detached from the improved telescoping branch trimmer.

FIG. 3 illustrates a schematic view of a cord self-retracting mechanism.

FIG. 4 illustrates a schematic view of an alternate cord self-retracting mechanism.

FIG. 5 illustrates a schematic view of an alternate cord self-retracting mechanism.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

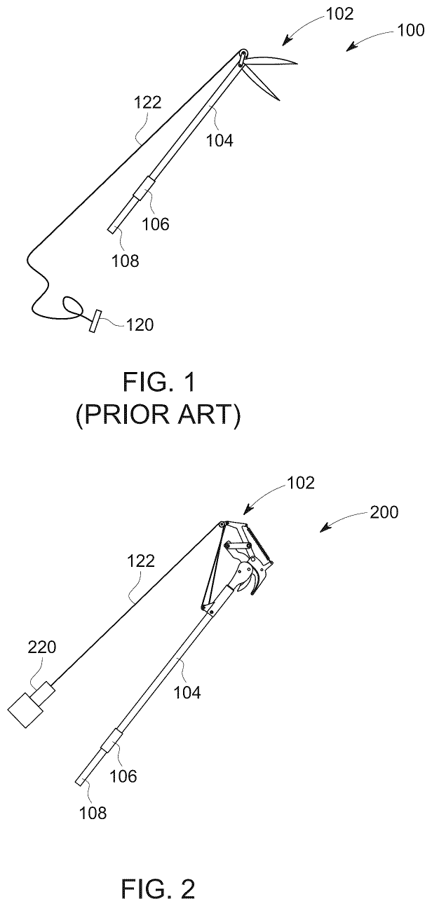

Referring to FIG. 1, a schematic view of a telescoping tree branch trimmer 100 of the prior art is shown. The telescoping tree branch trimmers 100 of the prior art includes a telescoping pole 104/108 with telescoping lock 106 for locking the length of the telescoping pole 104. There is a cutter head 102 at one end. A cord 122 (e.g., a rope) is attached at one end to an actuator of the cutter head 102 and there is a handle 120 at the other end of the cord 122. Often the telescoping pole 104/108 has a non-extended length of around 7 feet and an extended length of between 12 feet and 18 feet. The cord 122 is supplied at a length that is long enough to use when the telescoping pole 104/108 is fully extended. As shown in FIG. 1, telescoping pole 104/108 is retracted to a short length and the cord 122 has too much slack and, therefore, the handle 120 cannot be used to affect cutting of a branch by the cutter head 102. In this mode, the user often resorts to wrapping the cord 122 around their hand to provide enough leverage to close the jaws of the cutter head 102 and cut a branch. After cutting many branches, this process often leads to an irritated hand and possibly to abrasions of the user's skin due to slippage of the cord. Further, as the telescoping pole 104/108 is usually retracted to a short length for storage, something must be done with the cord 122 to prevent tangling, requiring extra effort to wrap the cord 122 around the telescoping pole 104/108 or manage the cord 122 in another way to prevent tangling and knotting.

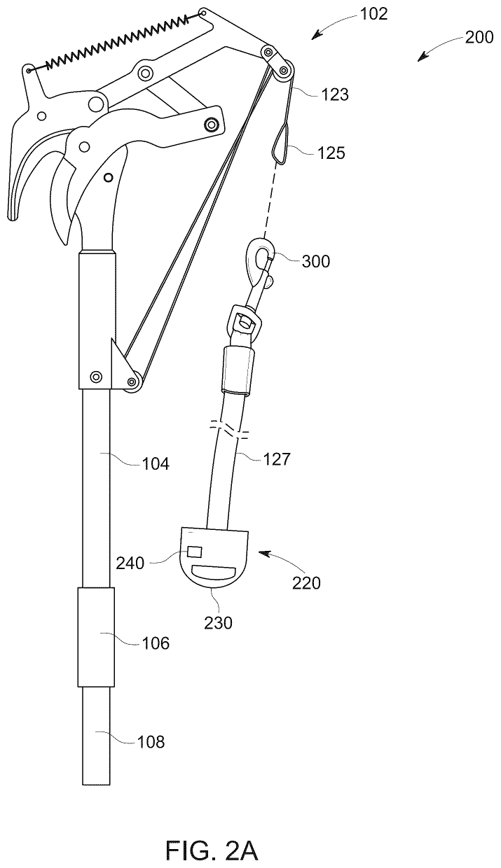

Referring to FIG. 2, a schematic view of an improved telescoping branch trimmer 200 with a cord self-retracting mechanism 220 is shown. The improved telescoping branch trimmer 200 includes telescoping pole sections 104/108 with telescoping lock 106 for locking the length of the telescoping pole 104. Note that the position, location, and type of the telescoping lock 106 is shown as an example and any position, location, and type of the telescoping lock 106 is anticipated. In some embodiments, the telescoping pole sections 104/108 have a non-extended length of around 7 feet and an extended length of between 12 feet and 18 feet. In some embodiments, the telescoping pole sections 104/108 are made of fiberglass.

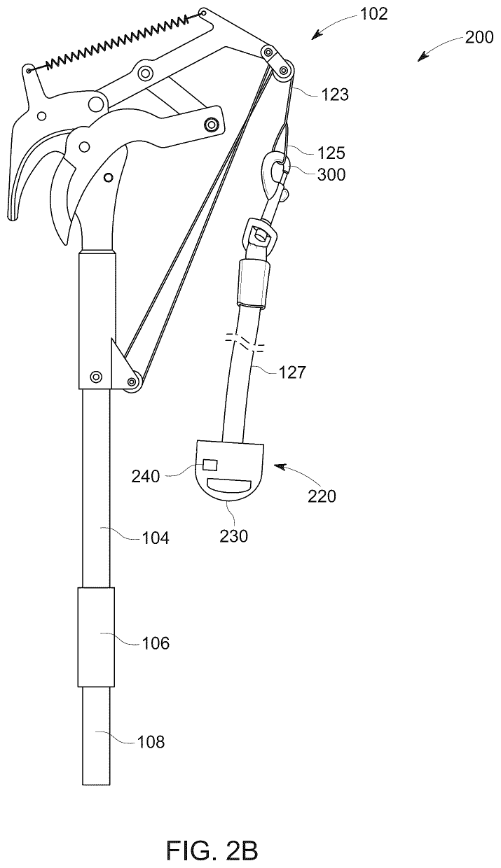

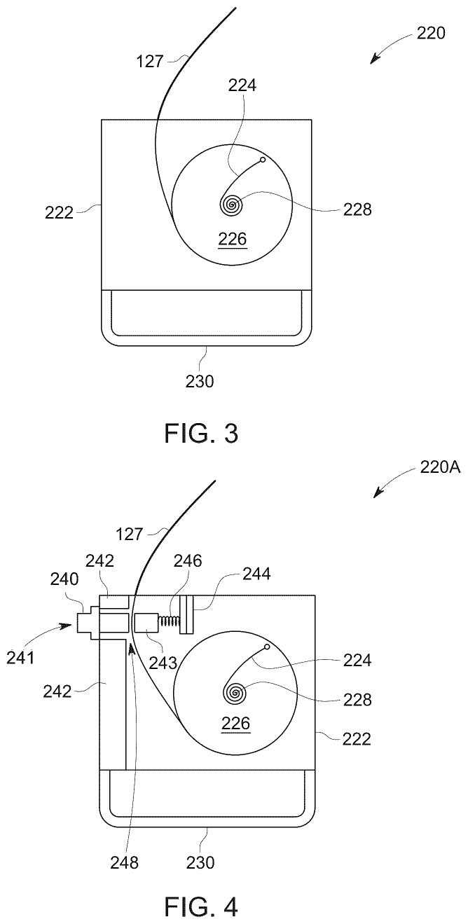

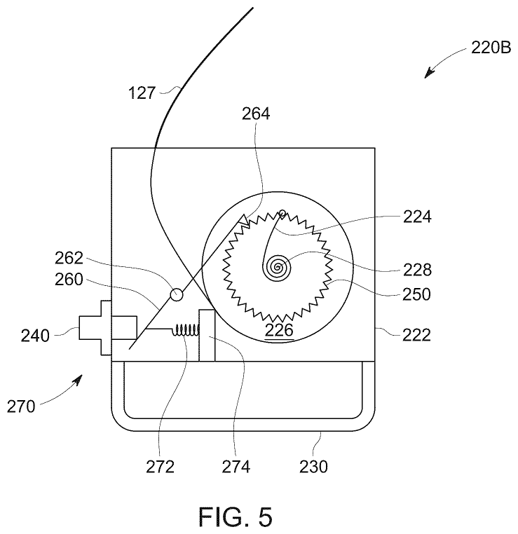

The improved telescoping branch trimmer 200 has a cutter head 102 at one end. A first end of a leader 127 (e.g., a cord, strap, belt) is attached to an actuator of the cutter head 102 and there is a cord self-retracting mechanism 220 at the other end of the leader 127. The leader 127 is supplied at a length that is long enough to use when the telescoping pole 104/106/108 is fully extended to a maximum length of the telescoping pole 104/106/108. When the telescoping pole 104/106/108 is not fully extended (a desired length that is less than a maximum length as set by the user), any excess length of the leader 127 is spooled within the cord self-retracting mechanism 220 and, in some embodiments, the cord self-retracting mechanism 220 has a lock as will be shown in FIGS. 4 and 5. In embodiments having the lock, pulling on the cord self-retracting mechanism 220 will operate the actuator of the cutter head 102. As shown in FIG. 2, telescoping pole 104/106/108 is retracted to a short length and some of the leader 127 is captured within the cord self-retracting mechanism 220, therefore, pulling the cord self-retracting mechanism 220 will affect cutting of a branch by the cutter head 102 when the cord self-retracting mechanism is locked. As the telescoping pole 104/106/108 is usually retracted to a short length for storage, it is anticipated that most of the leader 127 (e.g., at least 90% of the length of the cord) be retracted into the cord self-retracting mechanism 220 to prevent tangling and knotting. In some embodiments, the cord self-retracting mechanism 220 includes a handle 230 (see FIG. 3).

Referring to FIGS. 2A and 2B, a schematic view of an improved telescoping branch trimmer 200 with a cord self-retracting mechanism 220 is shown. The improved telescoping branch trimmer 200 includes telescoping pole sections 104/108 with telescoping lock 106 for locking the length of the telescoping pole 104. Note that the position, location, and type of the telescoping lock 106 is shown as an example and any position, location, and type of the telescoping lock 106 is anticipated. In some embodiments, the telescoping pole sections 104/108 have a non-extended length of around 7 feet and an extended length of between 12 feet and 18 feet. In some embodiments, the telescoping pole sections 104/108 are made of fiberglass.

The improved telescoping branch trimmer 200 has a cutter head 102 at one end. A first end of an actuation cord 123 is attached at one end to an actuator of the cutter head 102 and a second end of the actuation cord 123 has a loop 125. A longer leader 127 removably connects to the loop 125 and there is a cord self-retracting mechanism 220 at the other end of the leader 127 (or belt or strap). The leader 127 is supplied at a length that is long enough to use when the telescoping pole 104/106/108 is fully extended to a maximum length of the telescoping pole 104/106/108. When the telescoping pole 104/106/108 is not fully extended (a desired length that is less than a maximum length as set by the user), any excess length of the leader 127 is spooled within the cord self-retracting mechanism 220 (including the entire length of the leader 127 up to the connector 300). In some embodiments, the cord self-retracting mechanism 220 has a lock as will be shown in FIGS. 4 and 5. When the cord self-retracting mechanism 220 is locked, pulling on the cord self-retracting mechanism 220 will apply force to the leader 127 which is connected to the loop 125, applying force to the actuation cord 123 to operate the actuator of the cutter head 102. As shown in FIG. 2, telescoping pole 104/106/108 is retracted to a short length and some of the leader 127 is captured within the cord self-retracting mechanism 220, therefore, the pulling the cord self-retracting mechanism 220 will affect cutting of a branch by the cutter head 102 when the cord self-retracting mechanism is locked. As the telescoping pole 104/106/108 is usually retracted to a short length for storage, it is anticipated that most of the leader 127 (e.g., at least 90% of the length of the leader 127) be retracted into the cord self-retracting mechanism 220 to prevent tangling and knotting. In some embodiments, the cord self-retracting mechanism 220 includes a handle 230. In some embodiments, the cord self-retracting mechanism 220 includes an unlock button 240 (spring-loaded) that when pressed, allows the leader 127 to retract onto the spring-loaded spool 226 or be pulled out of the cord self-retracting mechanism 220 (e.g., see FIG. 3). In some embodiments, the unlock button 240 is dual action, allowing for locking and releasing.

It is known that with repeated use, cords 122 have a tendency to fray or break. Further, it is also known that where pullies are involved as in the cutter head 102 that is shown, it is better to utilize a cord or rope (e.g., the actuation cord 123) to traverse the pullies, but it is not always better for a person to grip a cord or rope as used for the actuation cord 123. Therefore, in some embodiments, the improved telescoping branch trimmer 200 has two features to overcome such obstacles. In some embodiments, the actuation cord 123 is a cord or rope and the leader 127 is a belt or strap that is more comfortable for gripping than a cord 122 or rope. In such, the leader 127 is attached to the actuation cord 123 at a loop 125 or tied in any way known in the industry. In some embodiments, there is a connector 300 that enables the leader 127 to be disconnected from the actuation cord 123 as desired, for example, for storage or for replacement when the leader 127 becomes frayed or broken. Note that one particular connector 300 is shown which is a metal swivel snap hook. The metal swivel snap hook is shown for clarity and brevity reasons, but any type of connector is anticipated such as a locking hook, a carabiner, etc.

Referring to FIG. 3, a schematic view of a cord self-retracting mechanism 220 of the improved telescoping branch trimmer 200 is shown. The cord self-retracting mechanism 220 includes a spring-loaded spool 226 that is held within an enclosure 222 by a central axle 228. The leader 127 attaches to the spring-loaded spool 226 and as the spring-loaded spool 226 turns, the cord wraps around the spring-loaded spool 226. Although many mechanisms for causing the spring-loaded spool 226 to turn are anticipated (e.g., a crank mechanism), a coil spring 224 is shown. The coil spring 224 biases or urges the spring-loaded spool 226 to wrap the leader 127 around the spring-loaded spool 226. As the leader 127 is pulled out of the cord self-retracting mechanism 220, the coil spring 224 is deformed/loaded, such that when the force of pulling abates, the coil spring 224 exerts rotational force on the spring-loaded spool 226 to cause the spring-loaded spool 226 to turn on the axle 228 and pull the leader 127 back into the cord self-retracting mechanism 220. The embodiment of FIG. 3 is an improvement over the prior art as any slack in the leader 127 is taken up by the cord self-retracting mechanism 220, keeping the leader 127 off the ground (e.g., removing a tripping and tangling hazard) and containing most of the leader 127 when the improved telescoping branch trimmer 200 is stored.

Referring to FIG. 4, a schematic view of an alternate cord self-retracting mechanism 220A is shown. The alternate cord self-retracting mechanism 220A includes a spring-loaded spool 226 that is held within an enclosure 222 by a central axle 228. The leader 127 attaches to the spring-loaded spool 226 and as the spring-loaded spool 226 turns, the cord wraps around the spring-loaded spool 226. Although many mechanisms for causing the spring-loaded spool 226 to turn are anticipated (e.g., a crank mechanism), a coil spring 224 is shown. The coil spring 224 biases the spring-loaded spool 226 to wrap the leader 127 around the spring-loaded spool 226. As the leader 127 is pulled out of the cord self-retracting mechanism 220A, the coil spring 224 is deformed/loaded, such that when the force of pulling abates, the coil spring 224 exerts rotational force on the spring-loaded spool 226 to cause the spring-loaded spool 226 to turn and pull the leader 127 back into the alternate cord self-retracting mechanism 220.A

In this embodiment, there is a spring-loaded locking mechanism 241. Although there are many spring-loaded locks anticipated, the spring-loaded locking mechanism 241 shown has an unlock button 240 that controls a locking bar 243. The leader 127 enters the enclosure 222 and passes through an orifice 248 in the locking bar 243. A compression spring 246 pushes against an internal structure 244 of the enclosure 222 and urges the locking bar 243 into the locked position and, hence, urges the unlock button towards the locked position in which the leader 127 is deformed between a locking block 242, therefore, holding the leader 127 within the locking block 242 and preventing the leader 127 from being pulled out of the alternate cord self-retracting mechanism 220A. When the unlock button 240 is pressed, the leader 127 is no longer deformed between the locking block 242 and is allowed to wrap around the spring-loaded spool 226 by force of the coil spring 224.

The embodiment of FIG. 4 is an improvement over the prior art as any slack in the leader 127 is taken up by the alternate cord self-retracting mechanism 220A, keeping the leader 127 off the ground (e.g., removing a tripping and tangling hazard) and containing most of the leader 127 when the improved telescoping branch trimmer 200 is stored. Further, when the unlock button 240 is released and the leader 127 is deformed between the locking block 242, pulling on the handle 230 (which is optional) or on the enclosure 222 of the alternate cord self-retracting mechanism 220A will exert a pulling force on the leader 127 that will affect the cutter head 102 to cut whatever is between the jaws of the cutter head 102.

Referring to FIG. 5, a schematic view of a second alternate cord self-retracting mechanism 220B is shown. The second alternate cord self-retracting mechanism 220B includes a spring-loaded spool 226 that is held within an enclosure 222 by a central axle 228. The leader 127 attaches to the spring-loaded spool 226 and as the spring-loaded spool 226 turns, the cord wraps around the spring-loaded spool 226. Although many mechanisms for causing the spring-loaded spool 226 to turn are anticipated (e.g., a crank mechanism), a coil spring 224 is shown. The coil spring 224 biases the spring-loaded spool 226 to wrap the leader 127 around the spring-loaded spool 226. As the leader 127 is pulled out of the cord self-retracting mechanism 220B, the coil spring 224 is deformed/loaded, such that when the force of pulling abates, the coil spring 224 exerts rotational force on the spring-loaded spool 226 to cause the spring-loaded spool 226 to turn and pull the leader 127 back into the alternate cord self-retracting mechanism 220B.

In this embodiment, there is a spring-loaded locking mechanism 270. Although there are many spring-loaded locks anticipated, the spring-loaded locking mechanism 270 shown has an unlock button 240 that controls force exerted on a locking arm 260. The locking arm 260 attaches to a pivot 262 and has a tooth 264 that selectively engages into teeth of a gear 250 that is rotatably locked to the spring-loaded spool 226 around the axle 228. A compression spring 272 (or expansion spring in some embodiments) pushes against a structure 274 within the enclosure 222 and urges the locking arm 260 into the locked position in which the tooth 264 is engaged between two of the teeth of the gear 250, thereby preventing the gear 250 and spring-loaded spool 226 from turning and locking the leader 127 around the spring-loaded spool 226, preventing the leader 127 from being pulled out of the enclosure 222. When the unlock button 240 is pressed, locking arm 260 pivots around the pivot 262 and the tooth 264 is disengaged from the teeth of the gear 250, thereby allowing the gear 250 and spring-loaded spool 226 to turn and pulling in the leader 127 around the spring-loaded spool 226 or allowing the leader 127 to be pulled from the spool of the enclosure 222.

The embodiment of FIG. 5 is an improvement over the prior art as any slack in the leader 127 is taken up by the second alternate cord self-retracting mechanism 220B, keeping the leader 127 off the ground (e.g., removing a tripping and tangling hazard) and containing most of the leader 127 when the improved telescoping branch trimmer 200 is stored. Further, when the unlock button 240 is released and the tooth 264 is disengaged from the teeth of the gear 250, pulling on the handle 230 (which is optional) or on the enclosure 222 of the alternate cord self-retracting mechanism 220B will exert a force on the leader 127 that will affect the cutter head 102 to cut whatever is between the jaws of the cutter head 102.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A telescoping branch trimmer comprising:
a telescoping pole, the telescoping pole having a telescoping lock for locking the telescoping pole after the telescoping pole is adjusted to a desired length;
a cutter head at one end of the telescoping pole, the cutter head having an actuation cord, one end of the actuation cord connected to a cutting blade of the cutter head such that a pulling force applied to the actuation cord causes the cutting blade to close and an opposite end of the actuation cord ending in a loop;
a leader, a first end of the leader is removably attached to the loop of the actuation cord;
an enclosure having a handle portion and having there within a spool that is rotatably mounted to the enclosure, whereas a second, distal end of the leader passes through the enclosure and is interfaced to the spool and the spool is configured to rotate within the enclosure to take in the leader, the spool is rotatably urged to take in the leader by a torsion spring and a locking mechanism is interfaced to the enclosure such that the locking mechanism prevents the leader from entering or exiting the enclosure unless an unlock button is operated at which time the torsion spring urges the spool to rotate and intake the leader onto the spool unless an outside force pulls on the leader, causing a force of the torsion spring to be overcome and, therefore, a portion of the leader exits the enclosure; and
whereas the enclosure is disconnected from the telescoping pole.

2. The telescoping branch trimmer of claim 1, wherein the spool rotates around an axle, the axle is affixed to the enclosure.

3. The telescoping branch trimmer of claim 1, wherein the leader is a strap.

4. The telescoping branch trimmer of claim 1, wherein the unlock button interfaced to a rod, the unlock button biased in a locked position, the leader passing through an orifice in the rod such that, in the locked position, the leader is deformed between a locking block, thereby preventing movement of the leader into or out of the enclosure and when the unlock button is pressed, the leader is moved away from the locking block, thereby allowing the movement of the leader into or out of the enclosure.

5. The telescoping branch trimmer of claim 1, wherein the enclosure comprises a handle.

6. A telescoping branch trimmer comprising:
a telescoping pole, the telescoping pole having a telescoping lock for locking the telescoping pole after the telescoping pole is adjusted to a desired length;
a cutter head at one end of the telescoping pole, the cutter head connected to a first end of an actuation cord such that applying a pulling force on a second end of the actuation cord closes a cutting mechanism of the cutter head;
an enclosure having therein a spring-loaded spool, a leader passes into the enclosure and a first end of the leader is interfaced to the spring-loaded spool such that the spring-loaded spool is configured to wind or unwind a portion of the leader;
a second end of the actuation cord is removably attached to a second end of the leader by a connector such that exertion of the pulling force on the leader causes the pulling force on the actuation cord to close the cutter head for cutting an object; and
whereas the connector removably attaches to the second end of the actuation cord to the second end of the leader when operating the telescoping branch trimmer and whereas the connector enables removal of the leader and the enclosure from the telescoping branch trimmer for storage and/or replacement.

7. The telescoping branch trimmer of claim 6, wherein a rotation of the spring-loaded spool is locked to the rotation of a gear and the spring-loaded spool and gear are interfaced to the enclosure by an axle, the spring-loaded spool is urged by a spring to wind the leader until the leader is pulled from the enclosure by an external force.

8. The telescoping branch trimmer of claim 7, further comprising a locking mechanism that prevents the leader from entering and from exiting the enclosure and an unlock button such that upon activation of the unlock button, the leader is free to spool out of the enclosure or to spool into the enclosure.

9. The telescoping branch trimmer of claim 8, wherein the locking mechanism comprises the unlock button interfaced to a locking arm, the unlock button biased in a locked position in which a tooth of the locking arm engages with teeth of the gear, the gear interfaced to the spring-loaded spool at the axle and the rotation of the spring-loaded spool is locked to the rotation of the gear, whereas in the locked position, the tooth of the locking arm engages with the teeth of the gear, disabling a movement of the leader into or out of the enclosure and when the unlock button is activated, the tooth of the locking arm disengages from the teeth of the gear, thereby allowing the movement of the leader into or out of the enclosure.

10. The telescoping branch trimmer of claim 6, the enclosure further comprising a handle.

11. The telescoping branch trimmer of claim 6, wherein the leader is a belt or strap.

12. The telescoping branch trimmer of claim 6, wherein the connector is a clip affixed to the second end of the actuation cord and the clip is removably interfaced to a loop at the second end of the leader.

13. The telescoping branch trimmer of claim 6, wherein the connector is a clip affixed to the second end of the leader and the clip is removably interfaced to a loop at the second end of the actuation cord.

14. The telescoping branch trimmer of claim 12, wherein the connector is a metal swivel snap hook.

15. The telescoping branch trimmer of claim 13, wherein the connector is a metal swivel snap hook.

16. A method of replacing the leader using the telescoping branch trimmer of claim 6, the method comprising:
adjusting the telescoping pole of the telescoping branch trimmer to a shortest length;
operating the connector of the enclosure to release the leader from the actuation cord;
providing a second enclosure having a second leader; and
operating the connector of the second leader to attach the second leader to the actuation cord.
